(19) United States
(12) Patent Application Publication
(10) Pub. No.: US 2026/0080552 A1
(43) Pub. Date: Mar. 19, 2026

(54) POINT CLOUD REGISTRATION METHOD, APPARATUS AND ELECTRONIC EQUIPMENT BASED ON PLANE FITTING

(71) Applicant: FAIR INNOVATION (SUZHOU) ROBOT SYSTEM CO., LTD., Jiangsu (CN)

(72) Inventors: Yu SONG, Jiangsu (CN); Jian SHU, Jiangsu (CN); Donghui DU, Jiangsu (CN); Shengnan GUO, Jiangsu (CN)

(21) Appl. No.: 19/109,270

(22) PCT Filed: Mar. 25, 2024
(86) PCT No.: PCT/CN2024/083538

§ 371 Date: Mar. 6, 2025

(30) Foreign Application Priority Data
Nov. 1, 2023 (CN) 202311433456.2

(51) Int. Cl. G06T 7/33

(52) U.S. Cl. CPC G06T 7/337; G06T 2207/10028

(57) ABSTRACT

The present disclosure provides a point cloud registration method, an apparatus and electronic equipment based on plane fitting, after obtaining the source point cloud and the to-be-registered point cloud, two non-parallel source planes in the source point cloud and two non-parallel to-be-registered planes in the to-be-registered point cloud are determined, a rotation matrix is calculated based on the two source planes and the two to-be-registered planes, and a translation vector is obtained based on the source point cloud and the to-be-registered point cloud. Finally, the to-be-registered point cloud is rotated and translated according to the rotation matrix and the translation vector, to realize a registration between the to-be-registered point cloud and the source point cloud. The present solution realizes the registration based on a correspondence between planes, rather than based on local features of points, which can greatly reduce amount of calculation and sensitivity to noise.

### CROSS-REFERENCE TO RELATED APPLICATION

The present disclosure claims the priority of the Chinese patent application with the Chinese Patent Office on Nov. 1, 2023 with application number 2023114334562 and the title “Point cloud registration method, apparatus and electronic equipment based on plane fitting”, the entire contents of which are incorporated herein by reference.

### TECHNICAL FIELD

The present disclosure relates to the field of computer technology, specifically, to a point cloud registration method, an apparatus and electronic equipment based on plane fitting.

### BACKGROUND ART

Point cloud registration is a process of matching one point cloud (to-be-registered point cloud) to another point cloud (source point cloud) based on a transformation matrix by calculating the transformation matrix (including a rotation matrix and a translation vector) between two point clouds, so as to achieve consistency of coordinates of the two point clouds. Since registration accuracy of the point cloud registration method directly affects reliability of subsequent processes such as error analysis, the point cloud registration is a key step in the fields of computer vision and computer-aided geometry such as three-dimensional model matching, target recognition, pose estimation and image matching.

The existing point cloud registration technology usually includes two processes: coarse registration and fine registration, in which the coarse registration process provides a good initial value of registration for fine registration. The existing point cloud coarse registration methods generally use a one-to-one correspondence between the points to achieve registration. This method adopted in the prior art has a problem of a huge amount of calculation because it is necessary to calculate the characteristics of the points in the to-be-registered point cloud point by point, and compare features of these points with the characteristics of the points in the source point cloud to determine a correct correspondence of the points. In addition, when calculating the features of a point, the methods adopted in the prior art usually use point cloud information of a neighborhood near the point, and when there is noise in the point cloud, a distribution of the point in the neighborhood near the point is affected, thereby affecting calculation of point features. Therefore, the method adopted in the prior art has defects of large amount of calculation and easy to be affected by noise.

### SUMMARY

The purposes of the present disclosure include, for example, providing a point cloud registration method, an apparatus and electronic equipment based on plane fitting, which enable registration between two-point clouds and reduce amount of calculation and sensitivity to noise.

An embodiment of the present disclosure may be realized as follows:

In a first aspect, the present disclosure provides a point cloud registration method based on plane fitting, including steps of:
obtaining a source point cloud and a to-be-registered point cloud;
determining two source planes in the source point cloud and two to-be-registered planes in the to-be-registered point cloud, wherein the two source planes are not parallel to each other, and the two to-be-registered planes are not parallel to each other;
calculating a rotation matrix based on the two source planes and the two to-be-registered planes, and obtaining a translation vector based on the source point cloud and the to-be-registered point cloud; and
rotating and translating the to-be-registered point cloud according to the rotation matrix and the translation vector, to realize a registration between the to-be-registered point cloud and the source point cloud.

In an optional embodiment, the step of determining two to-be-registered planes in the to-be-registered point cloud includes:
detecting all planes existing in the to-be-registered point cloud;
determining a largest plane as a first to-be-registered plane from all the planes detected, wherein a largest plane is the plane where the most points exist; and
determining a plane that is not parallel to the first to-be-registered plane in all the planes, and determining a largest plane as the second to-be-registered plane from all the planes that are not parallel to the first to-be-registered plane.

In an optional embodiment, the step of detecting all planes existing in the to-be-registered point cloud includes:
taking three points from all points of the to-be-registered point cloud each time, recording a plane passing through the taken out three points and counting the planes, wherein when planes determined by every three points are the same, counts thereof are increased by 1; and
when the counts of the planes reach a preset value, determining that the plane is detected, until all the planes in the to-be-registered point cloud are detected.

In an optional embodiment, the step of when the counts of the planes reach a preset value, determining that the plane is detected, until all the planes in the to-be-registered point cloud are detected, includes:
when the counts of the planes reach the preset value, determining that the plane is detected and sequentially calculating a distance from each point in the to-be-registered point cloud to the plane; and
deleting points in the to-be-registered point cloud whose distances are less than a preset distance, and taking three points from remaining points each time, recording planes passing through the taken out three points and recounting the planes to continue plane detection, until a number of the remaining points in the to-be-registered point cloud is less than a preset number, and determining that all the planes in the to-be-registered point cloud are detected.

In an optional embodiment, the source plane includes a first source plane and a second source plane, and the to-be-registered plane includes a first to-be-registered plane and a second to-be-registered plane,
wherein the step of calculating the rotation matrix based on the two source planes and the two to-be-registered planes includes:
calculating the rotation matrix under a first registration mode when the first to-be-registered plane corresponds to the first source plane and the second to-be-registered plane corresponds to the second source plane;
calculating the rotation matrix under a second registration mode when the second to-be-registered plane corresponds to the first source plane and the first to-be-registered plane corresponds to the second source plane; and
determining a final rotation matrix from rotation matrices under the first registration mode and the second registration mode.

In an optional embodiment, the step of determining a final rotation matrix from the rotation matrices under the first registration mode and the second registration mode includes:
calculating a first error between the to-be-registered point cloud that is registered under the first registration mode and the source point cloud, and a second error between the to-be-registered point cloud that is registered under the second registration mode and the source point cloud; and
determining the rotation matrix corresponding to a smallest error of the first error and the second error as the final rotation matrix.

In an optional embodiment, the step of calculating a first error between the to-be-registered point cloud that is registered under the first registration mode and the source point cloud includes:
traversing sequentially each point in the to-be-registered point cloud that is registered under the first registration mode, determining a point in the source point cloud that is closest to a point traversed in the to-be-registered point cloud, and calculating a distance between the closest point and the point traversed in the to-be-registered point cloud; and
accumulating distances corresponding to each point traversed, and obtaining the first error by dividing an accumulated value by a total number of points in the to-be-registered point cloud.

In an optional embodiment, the step of rotating and translating the to-be-registered point cloud according to the rotation matrix and the translation vector includes:
in a case of the first registration mode, obtaining normal vectors of the first to-be-registered plane and the first source plane respectively;
calculating an axis of rotation and an angle of rotation according to the normal vector of the first to-be-registered plane and the normal vector of the first source plane; and
rotating and translating the first to-be-registered plane and the second to-be-registered plane according to the axis of rotation, the angle of rotation, and the translation vector.

In a second aspect, the present disclosure provides a point cloud registration apparatus based on plane fitting, including:
an obtaining module, configured to obtain a source point cloud and a to-be-registered point cloud;
a determining module, configured to determine two source planes in the source point cloud and two to-be-registered planes in the to-be-registered point cloud, wherein the two source planes are not parallel to each other and the two to-be-registered planes are not parallel to each other;
a calculating module, configured to calculate a rotation matrix based on the two source planes and the two to-be-registered planes, and obtain a translation vector based on the source point cloud and the to-be-registered point cloud; and
a registration module, configured to rotate and translate the to-be-registered point cloud according to the rotation matrix and translation vector, to realize a registration of the to-be-registered point cloud and the source point cloud.

In a third aspect, the present disclosure provides electronic equipment, including a machine-readable storage medium and a processor, wherein the machine-readable storage medium stores machine-executable instructions, and when the processor executes the machine-executable instructions, the electronic equipment implements the method of any one of the preceding embodiments.

The beneficial effects of the embodiment of the present disclosure include, for example:

The present disclosure provides a point cloud registration method, an apparatus, and electronic equipment based on plane fitting, after obtaining the source point cloud and the to-be-registered point cloud, two non-parallel source planes in the source point cloud and two non-parallel to-be-registered planes in the to-be-registered point cloud are determined, a rotation matrix is calculated based on the two source planes and the two to-be-registered planes, and a translation vector is obtained based on the source point cloud and the to-be-registered point cloud. Finally, the to-be-registered point cloud is rotated and translated according to the rotation matrix and the translation vector, to realize a registration between the to-be-registered point cloud and the source point cloud. The present solution realizes the registration based on a correspondence between planes, rather than based on local features of points, which can greatly reduce the amount of calculation and sensitivity to noise.

### BRIEF DESCRIPTION OF DRAWINGS

In order to more clearly illustrate the technical solutions of the embodiments of the present disclosure, the drawings that need to be used in the embodiments will be briefly introduced below, and it should be understood that the following drawings only show some embodiments of the present disclosure and therefore should not be regarded as limiting the scope.

FIG. 1 is a flow chart of the point cloud registration method provided in the embodiment of the present disclosure;

FIG. 2 is a schematic diagram of two planes parallel to each other;

FIG. 3 is a schematic diagram of a source point cloud placed in a coordinate system;

FIG. 4 is a flow chart of the sub-steps contained in S12 in FIG. 1;

FIG. 5 is a flow chart of the sub-steps contained in S121 in FIG. 4;

FIG. 6 is a flow chart of the sub-steps contained in S13 in FIG. 1;

FIG. 7 is a flow chart of the sub-steps contained in S133 in FIG. 6;

FIG. 8 is a flowchart of the sub-steps contained in S1331 in FIG. 7;

FIG. 9 is a schematic diagram of the overall flow of the point cloud registration method provided in the embodiment of the present disclosure;

FIG. 10 is a schematic diagram of the overall flow of a plane detection method provided in the embodiment of the present disclosure;

FIG. 11 is a functional module block diagram of the point cloud registration apparatus provided in the embodiment of the present disclosure;

FIG. 12 is a structural block diagram of the electronic equipment provided in the embodiment of the present disclosure.

Numerals: 110—point cloud registration apparatus based on plane fitting; 111—obtaining module; 112—determining module; 113—calculating module; 114—registration module; 120—processor; 130—memory; 140—communication module.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below in conjunction with the accompanying drawings in the embodiments of the present disclosure, and it is obvious that the described embodiments are part of the embodiments of the present disclosure, not all embodiments. The components of the embodiment of the present disclosure, which are normally described and shown in the drawings herein, may be arranged and designed in a variety of different configurations.

Therefore, the following detailed description of the embodiments of the present disclosure provided in the drawings is not intended to limit the scope of the claimed application, but merely indicates the taken-out embodiments of the present disclosure. Based on the embodiments in the present disclosure, all other embodiments obtained by a person skilled in the art without creative work fall within the scope of protection of the present disclosure.

It should be noted that similar numerals and letters indicate similar terms in the drawings below, so that once an item is defined in a drawing, it does not need to be further defined and explained in subsequent drawings.

In the description of the present disclosure, it should be noted that the occurrence of the terms “first”, “second”, etc., is only used to distinguish the description and cannot be construed as indicating or implying relative importance.

It should be noted that, without conflict, the features in the embodiments of the present disclosure may be combined with each other.

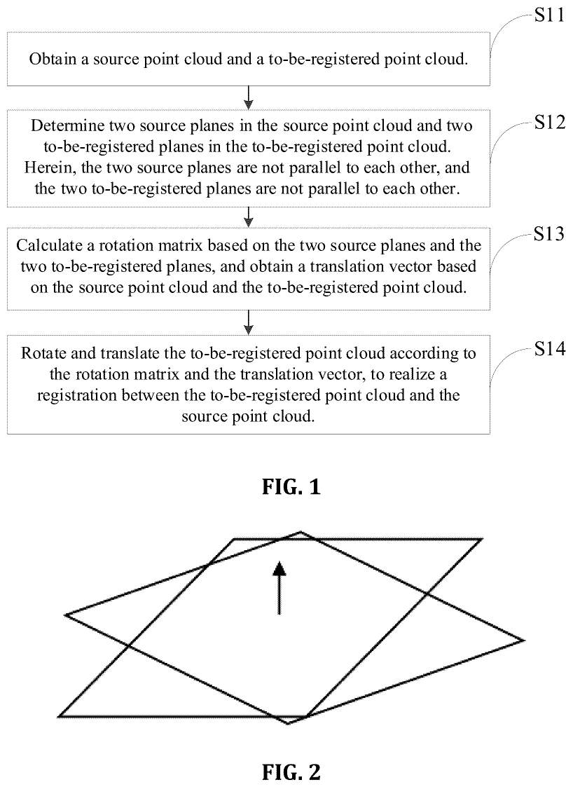

FIG. 1 shows a schematic diagram of the flow of a point cloud registration method based on plane fitting provided in the embodiment of the present disclosure, which can be performed by a point cloud registration apparatus that can be implemented by software and/or hardware, and can be configured in electronic equipment, and the electronic equipment can be computer equipment installed with related software. The detailed steps of this point cloud registration method based on plane fitting are described below.
S11, obtaining a source point cloud and a to-be-registered point cloud.
S12, determining two source planes in the source point cloud and two to-be-registered planes in the to-be-registered point cloud. Herein, the two source planes are not parallel to each other, and the two to-be-registered planes are not parallel to each other.
S13, calculating a rotation matrix based on the two source planes and the two to-be-registered planes and obtaining a translation vector based on the source point cloud and the to-be-registered point cloud.
S14, rotating and translating the to-be-registered point cloud according to the rotation matrix and the translation vector, to realize a registration between the to-be-registered point cloud and the source point cloud.

In the present embodiment, the source point cloud is set as P and the to-be-registered point cloud is set as Q, wherein the source point cloud is a workpiece-model point cloud constructed based on the workpiece model by using relevant software in a computer; and the to-be-registered point cloud is a point cloud composed of an image of a workpiece taken by a camera apparatus, such as a 3D camera. In general, there is no noise in the source point cloud, whereas noise is present in the to-be-registered point cloud.

Therefore, in the present embodiment, after obtaining the to-be-registered point cloud, a filtering process can be performed on the to-be-registered point cloud to remove some noise present in the to-be-registered point cloud. Here, the filtering processing may adopt methods in the prior art, and the embodiment is not limited herein.

Then, the planes in the to-be-registered point cloud are detected, two to-be-registered planes are determined from the detected planes, and similarly, two source planes in the source point cloud are determined. In the present embodiment, the two source planes are two planes that are not parallel to each other, and the two to-be-registered planes are two planes that are not parallel to each other, that is, there is a certain angle between the two. In the present embodiment, two mutually perpendicular planes can be taken out as the source plane, and two mutually perpendicular planes can be taken out as the to-be-registered planes.

In the present embodiment, the two source planes and the two to-be-registered planes are not parallel to each other respectively because if only a correspondence between a single plane is used, a pose transformation between the source point cloud and the to-be-registered point cloud cannot be completely determined. For example, as shown in FIG. 2, for two coincident planes, they have the same normal vector, but the two planes can rotate around the normal vector, so a unique pose transformation cannot be determined. Therefore, in the present embodiment, two source planes that are not parallel to each other and two to-be-registered planes that are not parallel to each other are taken out to determine the pose transformation between the source point cloud and the to-be-registered point cloud.

In the present embodiment, the rotation matrix is calculated based on the relationship between the two source planes and the two to-be-registered planes, for example, an axis of rotation, an angle of rotation, etc. can be calculated by the normal vectors of the two source planes and the two to-be-registered planes, and then the rotation matrix is obtained based on the axis of rotation and the angle of rotation.

In addition, the translation vector is obtained based on the source point cloud and the to-be-registered point cloud, and specifically, a position of a centroid of the source point cloud and a position of a centroid of the to-be-registered point cloud can be determined. The translation vector is obtained according to a difference between a centroid position of the source point cloud and a centroid position of the to-be-registered point cloud.

On this basis, the to-be-registered point cloud is rotated and translated according to the rotation matrix and translation vector, so that the to-be-registered point cloud matches the source point cloud after rotation and translation, that is, a consistency of coordinates is achieved, so as to realize the registration between the to-be-registered point cloud and the source point cloud.

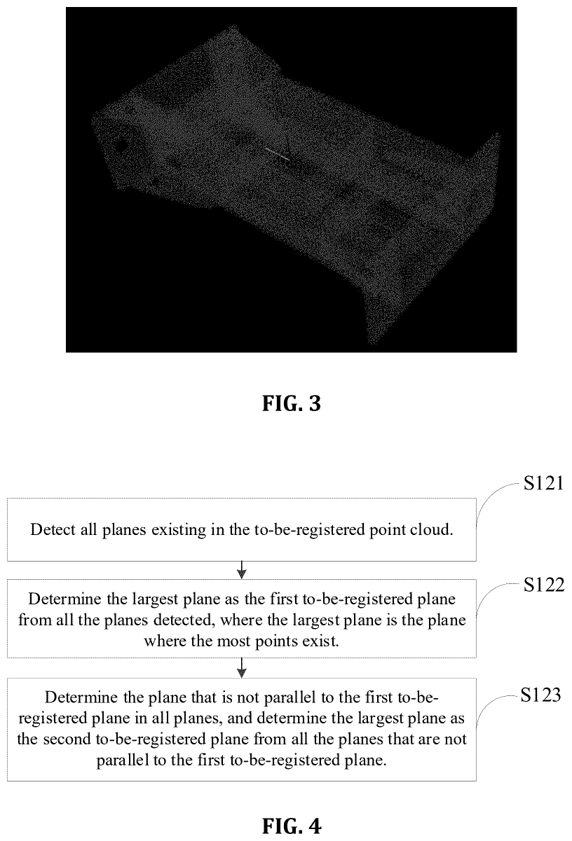

In the present embodiment, when performing registration, the source point cloud can be placed in a coordinate system in a certain way, for example, the centroid of the source point cloud is placed at the coordinate origin, one source planes is parallel to the xy plane, and the other source plane is parallel to the yz plane, as shown in FIG. 3. In addition, in the same way, the to-be-registered point cloud can be placed in the coordinate system, and registration between two-point clouds is performed in the coordinate system.

The point cloud registration method provided in the present embodiment is designed to realize a coarse registration between two-point clouds. Since point cloud coarse registration does not need to establish an exact correspondence between the point clouds, only an approximate pose transformation from the to-be-registered point cloud to the source point cloud needs to be given, so as to provide a good initial pose and facilitate a subsequent use of a fine registration algorithm for fine registration. Therefore, the point cloud coarse registration method should have a small amount of calculation and strong robustness, that is, when there is noise interference in the point cloud, the pose transformation between two-point clouds can still be given in a short time.

The point cloud registration method provided in the present embodiment does not rely on a one-to-one correspondence between the points in the registration process, but utilizes the correspondence between the planes to achieve coarse registration. Therefore, shortcomings of a large amount of calculation in the existing coarse registration methods can be overcome. Moreover, since the present embodiment is based on plane detection to achieve registration, not based on local features of the points, a sensitivity to noise can be greatly reduced. The method using plane detection relies on an overall distribution of the points on the plane in the point cloud, and even if there are some noise points at some locations in the point cloud, the local noise points do not affect the process of plane detection, nor will they affect the registration process. In general, the noise in the point cloud is characterized by undulations of points on a surface of an object, and these undulating points do not affect the plane detection process.

Therefore, the point cloud registration method based on plane fitting provided in the present embodiment realizes registration based on the correspondence between planes, instead of based on the local features of points, which can greatly reduce the amount of calculation, and greatly reduce the sensitivity to noise.

In the present embodiment, as a possible implementation, refer to FIG. 4, the step of determining the two to-be-registered planes in the to-be-registered point cloud may include the following sub-steps:
S121, detecting all planes existing in the to-be-registered point cloud.
S122, determining the largest plane as the first to-be-registered plane from all the planes detected, where the largest plane is the plane where the most points exist.
S123, determining the plane that is not parallel to the first to-be-registered plane in all planes, and determining the largest plane as the second to-be-registered plane from all the planes that are not parallel to the first to-be-registered plane.

In the present embodiment, each plane that exists in the to-be-registered point cloud is first detected, and then the plane where the most points exist in the detected plane is taken as the first to-be-registered plane. In addition to the first to-be-registered plane, the plane that is not parallel to the first to-be-registered plane and has the most points in remaining planes is the second to-be-registered plane. In the present embodiment, specifically, the second to-be-registered plane may be a plane perpendicular to the first to-be-registered plane.

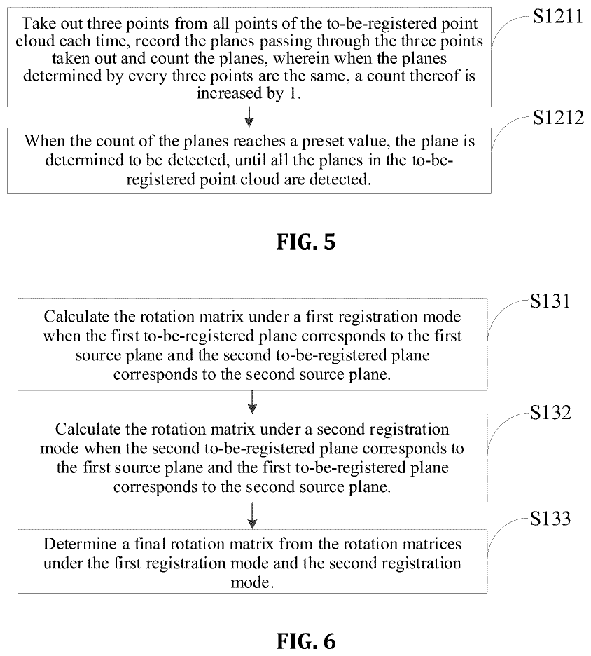

In the prior art, a 3D Hough transform method is generally used to detect the planes in the point cloud, and in a standard 3D Hough transform method, each time a point is taken out from the point cloud, and then all the planes passing through the point are calculate to realize the plane detection. In the present embodiment, an improved 3D Hough transform method is used to realize the detection of planes in the point cloud, which, with reference to FIG. 5, can be specifically achieved in the following way:
S1211, taking three points from all points of the to-be-registered point cloud each time, recording the planes passing through the three points taken out and counting the planes, wherein when the planes determined by every three points are the same, a count thereof is increased by 1.
S1212, when the count of the planes reaches a preset value, the plane is determined to be detected, until all the planes in the to-be-registered point cloud are detected.

In the improved 3D Hough transform method adopted in the present embodiment, three points are taken out from the to-be-registered point cloud each time, and the three points are any three points in the to-be-registered point cloud, and the plane passing through the three points is determined. When a plane is determined, the plane can be recorded and counted, wherein an array A(θ, φ, ρ) can be used to record the plane, and a subscript of the array A can be used to count. For implementation, the to-be-registered point cloud can be placed in a coordinate system that includes the x, y, and z axes. φ denotes an angle between a normal vector of the plane and the z-axis, θ denotes an angle between a projection of the normal vector of the plane on the xy plane and the x-axis, and ρ denotes a distance from the coordinate origin to the plane.

For planes recorded with the array A (θ, φ, ρ), the plane can be counted each time it is detected, with an initial value of 0, and the count is increased by 1 when the plane is detected.

In the present embodiment, after taking three points from the point cloud each time and determining a plane, and after recording and counting the planes, the taken out three points are put back into the point cloud, and then three points are taken out from the point cloud to determine the plane. The plane determined by the three points taken out later may be the same plane as the previously determined plane, in which case the count of the planes is increased by 1.

When the count of the planes reaches the preset value, it can be understood that the plane has been determined by the number of times corresponding to the preset value, and it can be determined that the plane is detected. In this way, multiple planes present in the to-be-registered point cloud can be detected.

The detection process of the planes in the to-be-registered point cloud cannot be endless, and in the present embodiment, in the case that certain conditions are satisfied, the detection process of the planes can be stopped, and all the planes in the to-be-registered point cloud are considered to have been detected at this time. Specifically, the process can be realized in the present embodiment in the following manner:

When the count of the planes reaches the preset value, determine that the plane is detected and a distance from each point in the to-be-registered point cloud to the plane is calculated sequentially. The points in the to-be-registered point cloud whose distance is less than the preset distance are deleted, and three points are taken out from remaining points each time, the plane passing through the three points taken out is recorded, and the plane is recounted to continue plane detection, until the number of the remaining points in the to-be-registered point cloud is less than the preset number, and it is determined that all the planes in the to-be-registered point cloud are detected.

In the present embodiment, each time a plane is detected, the distance from each point in the to-be-registered point cloud to the plane is calculated, and when the distance is less than the preset distance, that is, the corresponding point is on the plane or is in the vicinity of the plane, and the corresponding point can be deleted. Then continue the detection of other planes from remaining points. According to this method, the detected planes are more and more, and the remaining points in the point cloud are less and less, when the number of the remaining points is less than the preset number, it can be considered that all the planes in the point cloud have been detected, and the plane detection process can be ended.

In the present embodiment, the improved 3D Hough transform method is used to detect the planes in the point cloud, and compared with the standard 3D Hough transform method in which one point is taken out from the point cloud each time to detect the planes, the amount of calculation in the present embodiment can be greatly reduced.

In addition, the detection method for the plane in the source point cloud can be the same as that in the to-be-registered point cloud, and the method of determining two source planes from the planes in the source point cloud is the same as that of determining two to-be-registered planes from the to-be-registered point cloud.

In the present embodiment, the two source planes determined may be the first source plane and the second source plane, and the first source plane and the second source plane may be planes perpendicular to each other. In addition, the first to-be-registered plane and the second to-be-registered plane determined are planes perpendicular to each other.

Since there are generally at least two planes perpendicular to each other in the source point cloud and the to-be-registered point cloud, it is feasible to take two source planes perpendicular to each other (the first source plane and the second source plane) from the source point cloud. In the case that all the planes in the to-be-registered point cloud are detected, there must be two to-be-registered planes (the first to-be-registered plane and the second to-be-registered plane) corresponding to the two source planes in these planes.

Since the first source plane is the largest plane in the source point cloud, similarly, the largest plane in the to-be-registered point cloud is taken out as the first to-be-registered plane. The second source plane is the largest plane in the planes perpendicular to the first source plane, so similarly, the largest plane in the planes perpendicular to the first to-be-registered plane is taken out as the second to-be-registered plane. This method of taking planes is reasonable, and the comparison of correspondence can be reduced.

On this basis, the rotation matrix and translation vector can be obtained based on the determined two source planes and two to-be-registered planes. Since there are two correspondences between the two source planes and the two to-be-registered planes, there are different rotation matrices under different correspondences, specifically, with reference to FIG. 6, the calculation process of the rotation matrix can be achieved in the following way:
S131, calculating the rotation matrix under a first registration mode when the first to-be-registered plane corresponds to the first source plane and the second to-be-registered plane corresponds to the second source plane.
S132, calculating the rotation matrix under a second registration mode when the second to-be-registered plane corresponds to the first source plane and the first to-be-registered plane corresponds to the second source plane.
S133, determining a final rotation matrix from the rotation matrices under the first registration mode and the second registration mode.

In the present embodiment, the two correspondences are that the first to-be-registered plane corresponds to the first source plane and the second to-be-registered plane corresponds to the second source plane, and the second to-be-registered plane corresponds to the first source plane and the first to-be-registered plane corresponds to the second source plane, respectively. For these two correspondences, it is necessary to determine which correspondence is more reasonable, and the rotation matrix determined under the more reasonable correspondence is used as the final rotation matrix.

In the present embodiment, which of the above correspondences is more reasonable can be determined by error value, specifically, with reference to FIG. 7, can be realized in the following way:
S1331, calculating a first error between the to-be-registered point cloud that is registered under the first registration mode and the source point cloud, and a second error between the to-be-registered point cloud that is registered under the second registration mode and the source point cloud.
S1332, taking the rotation matrix corresponding to the smallest error of the first error and the second error as the final rotation matrix.

In the present embodiment, it is assumed that the registration is performed under the first registration mode, which can be achieved in the following manner:

In the case of the first registration mode, the normal vectors of the first to-be-registered plane and the first source plane are obtained respectively. The axis of rotation and the angle of rotation are calculated according to the normal vector of the first to-be-registered plane and the normal vector of the first source plane. The first to-be-registered plane and the second to-be-registered plane are rotated and translated according to the axis of rotation, the angle of rotation and the translation vector.

In the present embodiment, the to-be-registered point cloud can be rotated around the centroid of the to-be-registered point cloud, and in the case of translating the centroid based on the translation vector, the first to-be-registered plane is rotated to the first source plane and the second to-be-registered plane is rotated to the second source plane.

It is assumed that the normal vectors of the first registration plane and the first source plane are n₁ and n₂, respectively, the axis of rotation is nᵣₒₜ=n₁×n₂, and the rotation angles include θ_{rot,1} and θ_{rot,2}, where θ_{rot,1}=arccos (|n₁·n₂|), θ_{rot,2}=π−θ_{rot,1}.

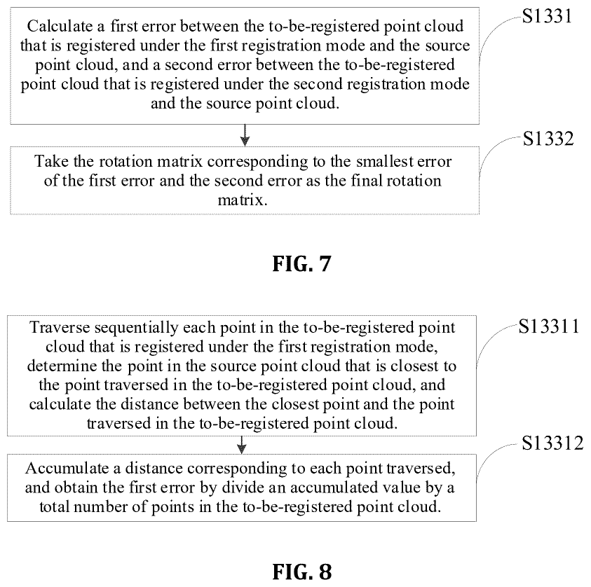

A rotational registration of the to-be-registered point cloud is performed under the first registration mode and the second registration mode respectively, and the to-be-registered point cloud after registration can be denoted as Q′. The error corresponding to the point cloud Q′ after registration under the two registration methods is calculated respectively. Herein, with reference to FIG. 8, the step of calculating the first error between the to-be-registered point cloud that is registered under the first registration mode and the source point cloud may include the following sub-steps:
S13311, sequentially traversing each point in the to-be-registered point cloud that is registered under the first registration mode, determining the point in the source point cloud that is closest to the point traversed in the to-be-registered point cloud, and calculating the distance between the closest point and the point traversed in the to-be-registered point cloud.
S13312, accumulating a distance corresponding to each point traversed, and obtaining the first error by dividing an accumulated value by a total number of points in the to-be-registered point cloud.

In the present embodiment, the registered error is calculated by a mode of the closest point, and in addition, the calculation method of the second error corresponding to the to-be-registered point cloud that is registered under the second registration mode is the same as the calculation method of the first error, and the present embodiment is not repeated herein.

If the obtained first error is smaller than the second error, it indicates that the correspondence under the first registration mode is more reasonable, and if the second error is smaller, it indicates that the correspondence under the second registration mode is more reasonable.

In the present embodiment, the rotation matrix between the corresponding planes under the registration mode with smaller error is taken out as the final rotation matrix, and the translation between the centroids of the two-point clouds is used as the translation vector.

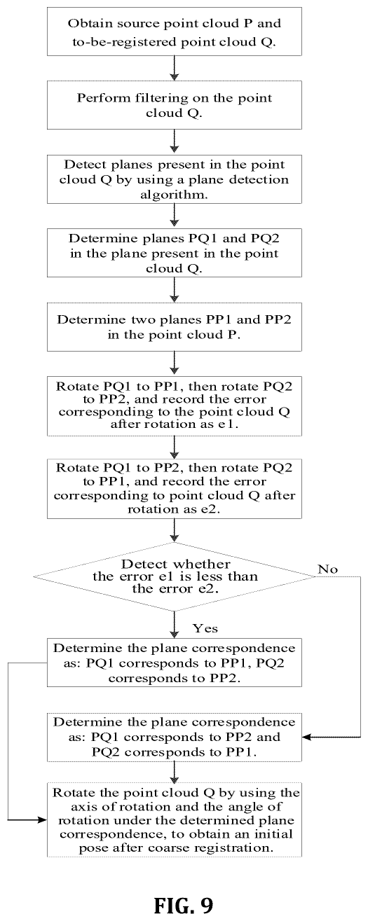

In order to have a clearer understanding of the point cloud registration method provided in the embodiment of the present disclosure, the overall implementation logic of the point cloud registration method shown in FIG. 9 will be introduced below.

Obtain source point cloud P and the to-be-registered point cloud Q.

Perform filtering on the cloud Q. This step can filter out the noise present in the point cloud Q.

Detect planes present in the point cloud Q by using a plane detection algorithm.

Determine planes PQ1 and PQ2 in the plane present in the point cloud Q. Herein, the plane PQ1 is the plane with the most points in the point cloud Q, and the plane PQ2 is the plane with the most points in the plane perpendicular to the plane PQ1.

Determine two planes PP1 and PP2 in the point cloud P. Herein, the plane PP1 is the plane with the most points in the point cloud P, and the plane PP2 is the plane with the most points in the plane perpendicular to the plane PP1.

Rotate PQ1 to PP1, then rotate PQ2 to PP2, and record the error corresponding to the point cloud Q after rotation as e1.

Rotate PQ1 to PP2, then rotate PQ2 to PP1, and record the error corresponding to point cloud Q after rotation as e2.

Detect whether the error e1 is less than the error e2, if the error el is less than the error e2, then determine the plane correspondence as: PQ1 corresponds to PP1, PQ2 corresponds to PP2.

If the error e1 is greater than or equal to the error e2, then the plane correspondence is determined as follows: PQ1 corresponds to PP2 and PQ2 corresponds to PP1.

The axis of rotation and the angle of rotation under the determined plane correspondence are used to rotate the point cloud Q to obtain an initial pose after coarse registration.

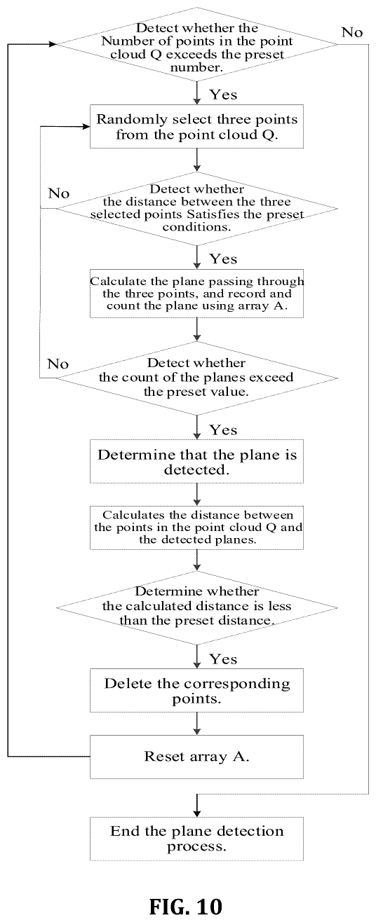

In conjunction with FIG. 10, the process of detecting the plane present in the point cloud Q using the plane detection algorithm in FIG. 9 is described.

First, check whether the number of points in the point cloud Q exceeds the preset number.

If the preset number is exceeded, three points are randomly taken from the point cloud Q.

Detect whether the distance between the three taken out points satisfies the preset conditions. The main purpose of this step is to avoid partial overlap of the three taken out points, resulting in inability to determine the plane.

If the distance between the taken out three points satisfies the preset conditions, the plane passing through the three points is calculated, and the plane is recorded and counted by array A. In addition, if the distance between the taken out three points does not satisfy the preset conditions, three points are taken out from the point cloud Q again. Herein, the count value of the plane is increased by 1 each time the plane is detected. The plane is recorded by array A (θ, φ, ρ), and subscript of array A is used to count the plane.

Detect whether the count of the planes exceed the preset value, if it does not exceed the preset value, the step of taking three points from the point cloud Q and determining the plane passing through the three points is continued; and if it exceeds the present value, the plane is determined to be detected.

Calculates the distance between the points in the point cloud Q and the detected planes.

Determine whether the calculated distance is less than the preset distance, if it is less than the preset distance, the corresponding point will be deleted. If the distance corresponding to the point is greater than or equal to the preset distance, the point is retained.

Reset array A and return to check whether the number of points remaining in the point cloud Q exceeds the preset number. When the points remaining in the point cloud is less than the preset number, the plane detection process is terminated.

The point cloud registration method provided in the present embodiment realizes point cloud coarse registration through plane detection and utilizing the correspondence between the detected plane and standard plane in the source point cloud. Herein, the improved 3D Hough transform is used to realize plane detection, which can speed up the plane detection. This method can avoid defects of large amount of calculation and sensitivity to noise in the existing traditional methods, and can greatly reduce the computational cost and sensitivity to noise.

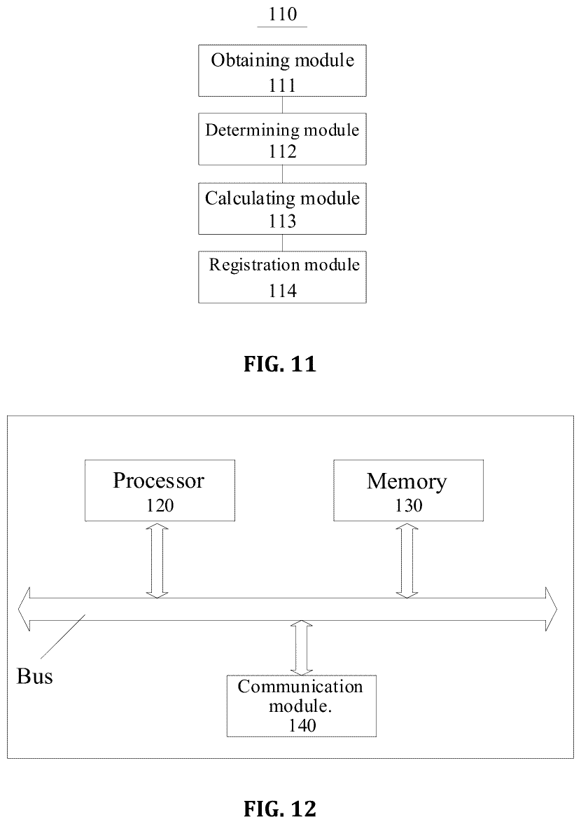

Based on the same invention idea, with reference to FIG. 11, a schematic diagram of a functional module of the point cloud registration apparatus 110 based on plane fitting provided in the embodiment of the present disclosure is shown, and the embodiment discloses a division of the functional module of the point cloud registration apparatus 110 based on plane fitting according to the above-mentioned method embodiment. For example, it is possible to divide individual function modules according to each function, or to integrate two or more functions in a single processing module. The above-mentioned integrated modules can be implemented in the form of either hardware or software function modules. It should be noted that the division of the module in the embodiment of the present disclosure is schematic, and is only a logical function division, and there can be other division modes when it is actually realized.

For example, in the case of dividing each functional module by adopting the corresponding functions, the point cloud registration apparatus 110 based on plane fitting shown in FIG. 11 is only a schematic diagram of the apparatus. Herein, the point cloud registration apparatus 110 based on plane fitting can include an obtaining module 111, a determining module 112, a calculating module 113 and a registration module 114, and the functions of each functional module of the point cloud registration apparatus 110 based on plane fitting are described in detail below.

The obtaining module 111 is configured to obtain a source point cloud and a to-be-registered point cloud;

it can be understood that the obtaining module 111 can be configured to execute the above step S11, and the detailed implementation related to the obtaining module 111 can refer to the content regarding the above step S11.

The determining module 112 is configured to determine two source planes in the source point cloud and two to-be-registered planes in the to-be-registered point cloud, wherein the two source planes are not parallel to each other and the two to-be-registered planes are not parallel to each other;

it can be understood that the determining module 112 can be configured to execute the above step S12, and the detailed implementation of the determining module 112 can refer to the content regarding the above step S12.

The calculating module 113 is configured to calculate a rotation matrix based on the two source planes and the two to-be-registered planes, and obtain a translation vector based on the source point cloud and the to-be-registered point cloud;

it can be understood that the calculating module 113 can be configured to execute the above step S13, and the detailed implementation of the calculating module 113 can refer to the content regarding the above step S13.

the registration module 114 is configured to rotate and translate the to-be-registered point cloud according to the rotation matrix and translation vector, to realize a registration of the to-be-registered point cloud and the source point cloud.

It can be understood that the registration module 114 can be configured to execute the above step S14, and the detailed implementation of the registration module 114 can refer to the content regarding the above step S14.

In a possible implementation, the above determining module 112 can be configured to:
detect all the planes existing in the to-be-registered point cloud;
determine the largest plane as the first to-be-registered plane from all the planes detected, wherein the largest plane is the plane where the most points exist; and
determine the plane that is not parallel to the first to-be-registered plane in all planes, and determine the largest plane as the second to-be-registered plane from all the planes that are not parallel to the first to-be-registered plane.

In a possible implementation, the above determining module 112 can be specifically configured to:
take out three points from all points of the to-be-registered point cloud each time, record the planes passing through the three points taken out and counting the planes, wherein when the planes determined by every three points are the same, a count thereof is increased by 1; and
when the count of the planes reaches a preset value, determine that the plane is detected, until all the planes in the to-be-registered point cloud are detected.

In a possible implementation, the above determining module 112 can be specifically configured to:
when the count of the planes reaches the preset value, determine that the plane is detected and calculate a distance from each point in the to-be-registered point cloud to the plane sequentially; and
delete the points in the to-be-registered point cloud whose distance is less than the preset distance, take out three points from remaining points each time, record the plane passing through the three points taken out and recount the planes to continue plane detection, until the number of the remaining points in the to-be-registered point cloud is less than the preset number, and determine that all the planes in the to-be-registered point cloud are detected.

In a possible embodiment, the source plane includes a first source plane and a second source plane, the to-be-registered plane includes a first to-be-registered plane and a second to-be-registered plane, and the calculating module 113 can be configured to:
calculate the rotation matrix under a first registration mode when the first to-be-registered plane corresponds to the first source plane and the second to-be-registered plane corresponds to the second source plane;
calculate the rotation matrix under a second registration mode when the second to-be-registered plane corresponds to the first source plane and the first to-be-registered plane corresponds to the second source plane; and
determine a final rotation matrix from the rotation matrices under the first registration mode and the second registration mode.

In a possible implementation, the calculating module 113 can be configured to:
calculate a first error between the to-be-registered point cloud that is registered under the first registration mode and the source point cloud, and a second error between the to-be-registered point cloud that is registered under the second registration mode and the source point cloud; and
take the rotation matrix corresponding to the smallest error of the first error and the second error as the final rotation matrix.

In a possible implementation, the calculating module 113 can be configured to:
sequentially traverse each point in the to-be-registered point cloud that is registered under the first registration mode, determine the point in the source point cloud that is closest to the point traversed in the to-be-registered point cloud, and calculate the distance between the closest point and the point traversed in the to-be-registered point cloud; and
accumulate a distance corresponding to each point traversed, and obtain the first error by dividing an accumulated value by a total number of points in the to-be-registered point cloud.

In a possible implementation, the registration module 114 can be configured to:
in the case of the first registration mode, respectively obtain the normal vectors of the first to-be-registered plane and the first source plane;
calculate the axis of rotation and the angle of rotation according to the normal vector of the first to-be-registered plane and the normal vector of the first source plane;
rotate and translate the first to-be-registered plane and the second to be registration plane according to the axis of rotation, the angle of rotation and the translation vector.

With reference to FIG. 12, which is a block diagram of the electronic equipment provided in the embodiment of the present disclosure, the electronic equipment may be the above-mentioned server terminal, and the electronic equipment includes a memory 130, a processor 120 and a communication module 140. Each element of the memory 130, the processor 120 and the communication module 140 is directly or indirectly electrically connected to each other to realize data transmission or interaction. For example, these elements can be electrically connected to each other via one or more communication buses or signal lines.

Herein, the memory 130 is configured to store programs or data. The Memory 130 can be, but is not limited to, Random Access Memory (RAM), Read Only Memory (ROM), Programmable Read Only Memory (PROM), Erasable Programmable Read Only Memory (EPROM), Electric Erasable Programmable Read Only Memory (EEPROM), etc.

The processor 120 is configured to read/write data or programs stored in the memory 130 and execute the point cloud registration method based on plane fitting provided in any embodiment of the present disclosure.

The communication module 140 is configured to establish a communication connection between the electronic equipment and other communication terminals through a network, and is configured to send and receive data through the network.

It should be understood that the structure shown in FIG. 12 is only a schematic diagram of the structure of the electronic equipment, which may also include more or fewer components than that shown in FIG. 12 or have a different configuration than that shown in FIG. 12.

Further, the embodiment of the present disclosure also provides a computer-readable storage medium, which stores machine-executable instructions, and the machine-executable instructions, when executed, implement the point cloud registration method based on plane fitting provided in the above embodiment.

Specifically, the computer-readable storage medium can be a general-purpose storage medium, such as a mobile disk, a hard disk, etc., and the computer program on the computer-readable storage medium, when run, performs the above-mentioned point cloud registration method based on plane fitting. With regard to the process involved in the computer-readable storage medium and when its executable instructions are run, reference can be made to the related description in the above method embodiment, which will not be described in detail here.

To sum up, the present disclosure provides a point cloud registration method, an apparatus and electronic equipment based on plane fitting, after obtaining the source point cloud and the to-be-registered point cloud, two non-parallel source planes in the source point cloud and two non-parallel to-be-registered planes in the to-be-registered point cloud are determined, a rotation matrix is calculated based on the two source planes and the two to-be-registered planes, and a translation vector is obtained based on the source point cloud and the to-be-registered point cloud. Finally, the to-be-registered point cloud is rotated and translated according to the rotation matrix and the translation vector, to realize a registration between the to-be-registered point cloud and the source point cloud. The present solution realizes the registration based on a correspondence between planes, rather than based on local features of points, which can greatly reduce amount of calculation and sensitivity to noise.

The above is only the specific embodiments of the present disclosure, but the scope of protection of the present disclosure is not limited to this, and any change or replacement that can be easily conceived by a person skilled in the art within the scope of the technology disclosed in the present disclosure shall be covered by the scope of protection of the present disclosure. Therefore, the scope of protection of the present disclosure shall be subject to the scope of protection of the claims.

1. A point cloud registration method based on plane fitting comprising steps of:
obtaining a source point cloud and a to-be-registered point cloud;
determining two source planes in the source point cloud and two to-be-registered planes in the to-be-registered point cloud, wherein the two source planes are not parallel to each other, and the two to-be-registered planes are not parallel to each other;
calculating a rotation matrix based on the two source planes and the two to-be-registered planes, and obtaining a translation vector based on the source point cloud and the to-be-registered point cloud; and
rotating and translating the to-be-registered point cloud according to the rotation matrix and the translation vector, to realize a registration between the to-be-registered point cloud and the source point cloud.

2. The point cloud registration method based on plane fitting according to claim 1, wherein the step of determining two to-be-registered planes in the to-be-registered point cloud comprises:
detecting all planes existing in the to-be-registered point cloud;
determining a largest plane as a first to-be-registered plane from all the planes detected, wherein the largest plane is a plane where the most points exist; and
determining a plane that is not parallel to the first to-be-registered plane in all the planes, and determining a largest plane as the second to-be-registered plane from all the planes that are not parallel to the first to-be-registered plane.

3. The point cloud registration method based on plane fitting according to claim 2, wherein the step of detecting all planes existing in the to-be-registered point cloud comprises:
taking three points from all points of the to-be-registered point cloud each time, recording a plane passing through the taken out three points, and counting the plane, wherein when planes determined by every three points are the same, counts thereof are increased by 1; and
when the counts of the planes reach a preset value, determining that the plane is detected, until all the planes in the to-be-registered point cloud are detected.

4. The point cloud registration method based on plane fitting according to claim 3, wherein the step of when the counts of the planes reach a preset value, determining that the plane is detected, until all the planes in the to-be-registered point cloud are detected, comprises:
when the counts of the planes reach the preset value, determining that the plane is detected and sequentially calculating a distance from each point in the to-be-registered point cloud to the plane; and
deleting points in the to-be-registered point cloud whose distances are less than a preset distance, and taking three points from remaining points each time, recording planes passing through the taken out three points and recounting the planes to continue plane detection, until a number of the remaining points in the to-be-registered point cloud is less than a preset number, and determining that all the planes in the to-be-registered point cloud are detected.

5. The point cloud registration method based on plane fitting according to claim 1, wherein the source plane comprises a first source plane and a second source plane, and the to-be-registered plane comprises a first to-be-registered plane and a second to-be-registered plane,
wherein the step of calculating the rotation matrix based on the two source planes and the two to-be-registered planes comprises:
calculating the rotation matrix under a first registration mode when the first to-be-registered plane corresponds to the first source plane, and the second to-be-registered plane corresponds to the second source plane;
calculating the rotation matrix under a second registration mode when the second to-be-registered plane corresponds to the first source plane, and the first to-be-registered plane corresponds to the second source plane; and
determining a final rotation matrix from rotation matrices under the first registration mode and the second registration mode.

6. The point cloud registration method based on plane fitting according to claim 5, wherein the step of determining a final rotation matrix from the rotation matrices under the first registration mode and the second registration mode comprises:
calculating a first error between the to-be-registered point cloud that is registered under the first registration mode and the source point cloud, and a second error between the to-be-registered point cloud that is registered under the second registration mode and the source point cloud; and
determining the rotation matrix corresponding to a smallest error of the first error and the second error as the final rotation matrix.

7. The point cloud registration method based on plane fitting according to claim 6, wherein the step of calculating a first error between the to-be-registered point cloud that is registered under the first registration mode and the source point cloud comprises:
traversing sequentially each point in the to-be-registered point cloud that is registered under the first registration mode, determining a point in the source point cloud that is closest to a point traversed in the to-be-registered point cloud, and calculating a distance between the closest point and the point traversed in the to-be-registered point cloud; and
accumulating distances corresponding to each point traversed, and obtaining the first error by dividing an accumulated value by a total number of points in the to-be-registered point cloud.

8. The point cloud registration method based on plane fitting according to claim 5, wherein the step of rotating and translating the to-be-registered point cloud according to the rotation matrix and the translation vector comprises:
in a case of the first registration mode, obtaining normal vectors of the first to-be-registered plane and the first source plane, respectively;
calculating an axis of rotation and an angle of rotation according to the normal vector of the first to-be-registered plane and the normal vector of the first source plane; and
rotating and translating the first to-be-registered plane and the second to-be-registered plane according to the axis of rotation, the angle of rotation, and the translation vector.

9. A point cloud registration apparatus based on plane fitting comprising:
an obtaining module, configured to obtain a source point cloud and a to-be-registered point cloud;
a determining module, configured to determine two source planes in the source point cloud and two to-be-registered planes in the to-be-registered point cloud, wherein the two source planes are not parallel to each other and the two to-be-registered planes are not parallel to each other;
a calculating module, configured to calculate a rotation matrix based on the two source planes and the two to-be-registered planes, and obtain a translation vector based on the source point cloud and the to-be-registered point cloud; and
a registration module, configured to rotate and translate the to-be-registered point cloud according to the rotation matrix and translation vector, to realize a registration of the to-be-registered point cloud and the source point cloud.

10. An electronic equipment, comprising a machine-readable storage medium and a processor, wherein the machine-readable storage medium stores machine-executable instructions, and when the processor executes the machine-executable instructions, the electronic equipment implements the method of claim 1.

11. The electronic equipment according to claim 10, wherein when the processor executes the machine-executable instructions, the electronic equipment implements the method as follows:
detecting all planes existing in the to-be-registered point cloud;
determining a largest plane as a first to-be-registered plane from all the planes detected, wherein the largest plane is a plane where the most points exist; and
determining a plane that is not parallel to the first to-be-registered plane in all the planes, and determining a largest plane as the second to-be-registered plane from all the planes that are not parallel to the first to-be-registered plane.

12. The electronic equipment according to claim 11, wherein when the processor executes the machine-executable instructions, the electronic equipment implements the method as follows:
taking three points from all points of the to-be-registered point cloud each time, recording a plane passing through the taken out three points, and counting the plane, wherein when planes determined by every three points are the same, counts thereof are increased by 1; and
when the counts of the planes reach a preset value, determining that the plane is detected, until all the planes in the to-be-registered point cloud are detected.

13. The electronic equipment according to claim 12, wherein when the processor executes the machine-executable instructions, the electronic equipment implements the method as follows:
when the counts of the planes reach the preset value, determining that the plane is detected and sequentially calculating a distance from each point in the to-be-registered point cloud to the plane; and
deleting points in the to-be-registered point cloud whose distances are less than a preset distance, and taking three points from remaining points each time, recording planes passing through the taken out three points and recounting the planes to continue plane detection, until a number of the remaining points in the to-be-registered point cloud is less than a preset number, and determining that all the planes in the to-be-registered point cloud are detected.

14. The electronic equipment according to claim 10, wherein when the processor executes the machine-executable instructions, the electronic equipment implements the method as follows:
wherein the step of calculating the rotation matrix based on the two source planes and the two to-be-registered planes comprises:
calculating the rotation matrix under a first registration mode when the first to-be-registered plane corresponds to the first source plane, and the second to-be-registered plane corresponds to the second source plane;
calculating the rotation matrix under a second registration mode when the second to-be-registered plane corresponds to the first source plane, and the first to-be-registered plane corresponds to the second source plane; and
determining a final rotation matrix from rotation matrices under the first registration mode and the second registration mode.

15. The electronic equipment according to claim 14, wherein when the processor executes the machine-executable instructions, the electronic equipment implements the method as follows:
calculating a first error between the to-be-registered point cloud that is registered under the first registration mode and the source point cloud, and a second error between the to-be-registered point cloud that is registered under the second registration mode and the source point cloud; and
determining the rotation matrix corresponding to a smallest error of the first error and the second error as the final rotation matrix.

16. The electronic equipment according to claim 15, wherein when the processor executes the machine-executable instructions, the electronic equipment implements the method as follows:
traversing sequentially each point in the to-be-registered point cloud that is registered under the first registration mode, determining a point in the source point cloud that is closest to a point traversed in the to-be-registered point cloud, and calculating a distance between the closest point and the point traversed in the to-be-registered point cloud; and
accumulating distances corresponding to each point traversed, and obtaining the first error by dividing an accumulated value by a total number of points in the to-be-registered point cloud.

17. The electronic equipment according to claim 14, wherein when the processor executes the machine-executable instructions, the electronic equipment implements the method as follows:
in a case of the first registration mode, obtaining normal vectors of the first to-be-registered plane and the first source plane, respectively;
calculating an axis of rotation and an angle of rotation according to the normal vector of the first to-be-registered plane and the normal vector of the first source plane; and
rotating and translating the first to-be-registered plane and the second to-be-registered plane according to the axis of rotation, the angle of rotation, and the translation vector.
